(19) United States
(12) Patent Application Publication
(10) Pub. No.: US 2023/0354264 A1
(43) Pub. Date: Nov. 2, 2023

(54) BASE STATION, USER EQUIPMENT, AND NETWORK NODE

(71) Applicants: DENSO CORPORATION, Kariya-city (JP); TOYOTA JIDOSHA KABUSHIKI KAISHA, Toyota-shi (JP)

(72) Inventors: Tomoyuki YAMAMOTO, Kariya-city (JP); Hideaki TAKAHASHI, Kariya-city (JP)

(21) Appl. No.: 18/349,582

(22) Filed: Jul. 10, 2023

Related U.S. Application Data
(63) Continuation of application No. PCT/JP2021/045587, filed on Dec. 10, 2021.

(30) Foreign Application Priority Data
Jan. 13, 2021 (JP) 2021-003695

(51) Int. Cl. H04W 68/02

(52) U.S. Cl. CPC H04W 68/02

(57) ABSTRACT

A base station according to an aspect of the present disclosure includes: a memory storing a program; and one or more processors configured to execute the program to: obtain quality of service, QoS, information indicating QoS of a service for which a paging to a user equipment is performed; and transmit the QoS information with a paging message for the paging.

### CROSS-REFERENCE TO RELATED APPLICATIONS

This application is based on and claims the benefit of priority from Japanese Patent Application No. 2021-003695, filed on Jan. 13, 2021, the entire content of which is incorporated herein by reference.

### BACKGROUND

### 1. Technical Field

The present disclosure relates to a base station, a user equipment, and a network node.

### 2. Related Art

In 3rd Generation Partnership Project (3GPP) Release 17, a work item has been launched for formulating functions to monitor for information of incoming call (for example, voice or data) from multiple telecommunications operators' networks for devices equipped with multiple subscriber identity module (SIM) cards.

### SUMMARY

A base station according to an aspect of the present disclosure includes: a memory storing a program; and one or more processors configured to execute the program to: obtain quality of service, QoS, information indicating QoS of a service for which a paging to a user equipment is performed; and transmit the QoS information with a paging message for the paging.

A user equipment according to an aspect of the present disclosure includes: a memory storing a program; and one or more processors configured to execute the program to: receive quality of service, QoS, information indicating QoS of a service for which a paging to the user equipment is performed, the QoS information being transmitted with a paging message for the paging by a base station; and determine, based on the QoS information, whether to interrupt an ongoing service in a further mobile network.

A network node within a core network according to an aspect of the present disclosure includes: a memory storing a program; and one or more processors configured to execute the program to: obtain quality of service, QoS, information indicating QoS of a service for which a paging to a user equipment (200) is performed; and transmit, to a base station (100), a message for the paging, the message including the QoS information.

### BRIEF DESCRIPTION OF THE DRAWINGS

FIG. 1 is an explanatory diagram illustrating an example of a schematic configuration of a system according to embodiments of the present disclosure.

FIG. 2 is an explanatory diagram for explaining an example of a case where a user equipment according to embodiments of the present disclosure is equipped with two SIM cards.

FIG. 3 is a block diagram illustrating an example of a schematic functional configuration of a base station according to embodiments of the present disclosure.

FIG. 4 is a block diagram illustrating an example of a schematic hardware configuration of the base station according to embodiments of the present disclosure.

FIG. 5 is a block diagram illustrating an example of a schematic functional configuration of the user equipment according to embodiments of the present disclosure.

FIG. 6 is a block diagram illustrating an example of a schematic hardware configuration of the user equipment according to embodiments of the present disclosure.

FIG. 7 is a block diagram illustrating an example of a schematic functional configuration of a network node according to embodiments of the present disclosure.

FIG. 8 is a block diagram illustrating an example of a schematic hardware configuration of the network node according to embodiments of the present disclosure.

FIG. 9 is a sequence diagram for explaining an example of a schematic flow of processing according to embodiments of the present disclosure.

FIG. 10 is a diagram for explaining a first example of a short message according to a first modification example of embodiments of the present disclosure.

FIG. 11 is a diagram for explaining a first example of direct indication information according to the first modification example of embodiments of the present disclosure.

FIG. 12 is a diagram for explaining a second example of a short message according to the first modification example of embodiments of the present disclosure.

FIG. 13 is a diagram for explaining a second example of direct indication information according to the first modification example of embodiments of the present disclosure.

FIG. 14 is a sequence diagram for explaining an example of a schematic flow of processing according to the first modification example of embodiments of the present disclosure.

FIG. 15 is a diagram for explaining an example of a short message according to a further embodiment.

FIG. 16 is a diagram for explaining an example of direct indication information according to the further embodiment.

FIG. 17 is a diagram for explaining another example of direct indication information according to the further embodiment.

FIG. 18 is a sequence diagram for explaining an example of a schematic flow of processing according to the further embodiment.

### DETAILED DESCRIPTION OF THE PREFERRED EMBODIMENTS

For example, R2-2009325 and R2-2010535 in 3GPP TSG-RAN WG2 Meeting #112e disclose that, in order for a user equipment (UE) to determine whether to interrupt an ongoing service in one network and respond to a paging in another network, a paging cause is included in a paging message. R2-2009325 and R2-2010535 describe that, as an example, the paging cause indicates whether or not a service for which the paging to the UE is performed is voice over long term evolution (VoLTE) or voice over new radio (VoNR).

A detailed study by the inventors has revealed an issue that, since the specific paging cause (that is, whether VoLTE/VoNR or not) described in R2-2009325 and R2-2010535 is very limited information, it is still difficult to appropriately determine whether to interrupt an ongoing service in a further network even considering this paging cause.

An object of the present disclosure is to provide a base station, a user equipment, and a network node that make it possible to more appropriately determine whether to interrupt an ongoing service in a further mobile network to respond to a paging.

A base station according to an aspect of the present disclosure includes: an information obtaining unit configured to obtain quality of service, QoS, information indicating QoS of a service for which a paging to a user equipment is performed; and a communication processing unit configured to transmit the QoS information with a paging message for the paging.

A user equipment according to an aspect of the present disclosure includes: a communication processing unit configured to receive quality of service, QoS, information indicating QoS of a service for which a paging to the user equipment is performed, the QoS information being transmitted with a paging message for the paging by a base station; and a control unit configured to determine, based on the QoS information, whether to interrupt an ongoing service in a further mobile network.

A network node within a core network according to an aspect of the present disclosure includes: an information obtaining unit configured to obtain quality of service, QoS, information indicating QoS of a service for which a paging to a user equipment is performed; and a communication processing unit configured to transmit, to a base station, a message for the paging, the message including the QoS information.

A method performed by a base station according to an aspect of the present disclosure includes: obtaining quality of service, QoS, information indicating QoS of a service for which a paging to a user equipment is performed; and transmitting the QoS information with a paging message for the paging.

A method performed by a user equipment according to an aspect of the present disclosure includes: receiving quality of service, QoS, information indicating QoS of a service for which a paging to the user equipment is performed, the QoS information being transmitted with a paging message for the paging by a base station; and determining, based on the QoS information, whether to interrupt an ongoing service in a further mobile network.

According to the present disclosure, it is possible to more appropriately determine whether to interrupt an ongoing service in a further mobile network to respond to a paging. Note that, instead of or in addition to this advantageous effect, the present disclosure may yield another advantageous effect.

Hereinafter, embodiments of the present disclosure will be described in detail with reference to the appended drawings. In the present specification and the drawings, elements to which similar descriptions are applicable are denoted with the same reference signs, thereby omitting duplicate descriptions.

Descriptions will be given in the following order:

1. Configuration of System

2. Configuration of Base Station

3. Configuration of User Equipment

4. Configuration of Network Node

5. Operation Examples

6. Modification Examples

7. Further Embodiment

### 1. Configuration of System

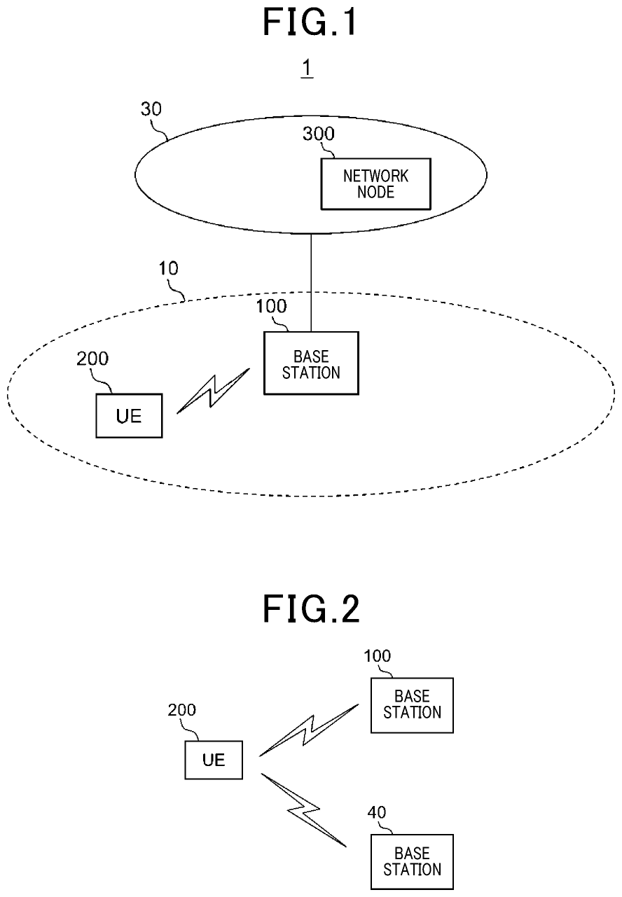

An example of a configuration of a system 1 according to embodiments of the present disclosure will be described with reference to FIG. 1. Referring to FIG. 1, the system 1 includes a base station 100, a user equipment (UE) 200, and a core network 30. The core network 30 includes a network node 300.

For example, the system 1 is a system compliant with technical specifications (TSs) of 3GPP. More specifically, for example, the system 1 is a system compliant with TSs of 5G or new radio (NR). Alternatively, the system 1 may be a system compliant with TSs of long term evolution (LTE), LTE advanced (LTE-A), or 4th generation (4G). Naturally, the system 1 is not limited to this example.

(1) Base Station 100

The base station 100 is a node in a radio access network (RAN) and communicates with a UE (for example, the UE 200) located within a coverage area 10 of the base station 100.

For example, the base station 100 communicates with a UE (for example, the UE 200) using a RAN protocol stack. For example, the protocol stack includes a radio resource control (RRC) layer, a service data adaptation protocol (SDAP) layer, a packet data convergence protocol (PDCP) layer, a radio link control (RLC) layer, a medium access control (MAC) layer, and a physical (PHY) layer. Alternatively, the protocol stack may include some, but not all, of these layers.

For example, the base station 100 is a gNB. The gNB is a node that provides NR user plane and control plane protocol terminations towards a UE and is connected to the 5G core network (5GC) via an NG interface. The base station 100 may be an en-gNB. Alternatively, the base station 100 may be an eNB or an ng-eNB.

The base station 100 may include a plurality of nodes. The plurality of nodes may include a first node that hosts higher layers included in the protocol stack and a second node that hosts lower layers included in the protocol stack. The higher layers may include the RRC layer, the SDAP layer, and the PDCP layer, while the lower layers may include the RLC layer, the MAC layer, and the PHY layer. The first node may be a central unit (CU), and the second node may be a distributed unit (DU). Note that the plurality of nodes may include a third node that performs lower processing of the PHY layer, and the second node may perform higher processing of the PHY layer. The third node may be a radio unit (RU).

Alternatively, the base station 100 may be one of the plurality of nodes, and may be connected to another unit of the plurality of nodes.

The base station 100 may be an integrated access and backhaul (IAB) donor or an TAB node.

(2) UE 200

The UE 200 communicates with a base station. For example, the UE 200 communicates with the base station 100 when being located within the coverage area 10 of the base station 100.

For example, the UE 200 communicates with a base station (for example, the base station 100) using the protocol stack.

In particular, the UE 200 is capable of being equipped with two or more SIM cards That is, the UE 200 is a multi-SIM UE or a multi-SIM device. The UE 200 is capable of communicating in two or more mobile networks respectively corresponding to the two or more SIM cards.

For example, the UE 200 can communicate in a mobile network (hereinafter, referred to as “first mobile network”) that corresponds to one of the two or more SIM cards and includes the base station 100 and the network node 300. Further, the UE 200 can communicate in another mobile network (hereinafter, referred to as “second mobile network”) that corresponds to another one of the two or more SIM cards. The first mobile network is different from the second mobile network.

Referring to the example of FIG. 2, for example, the UE 200 can communicate in the first mobile network including the base station 100 and in the second mobile network including a base station 40. For example, the UE 200 may be in an RRC idle state or RRC inactive state in the first mobile network, and may be in an RRC connected state in the second mobile network. In such a case, for example, the UE 200 may receive a paging message transmitted by the base station 100 in the first mobile network when having an ongoing service in the second mobile network.

(3) Network Node 300

The network node 300 is a network function of the core network 30. For example, the network node 300 is an access and mobility management function (AMF). Alternatively, the network node 300 may be a mobility management entity (MME).

### 2. Configuration of Base Station

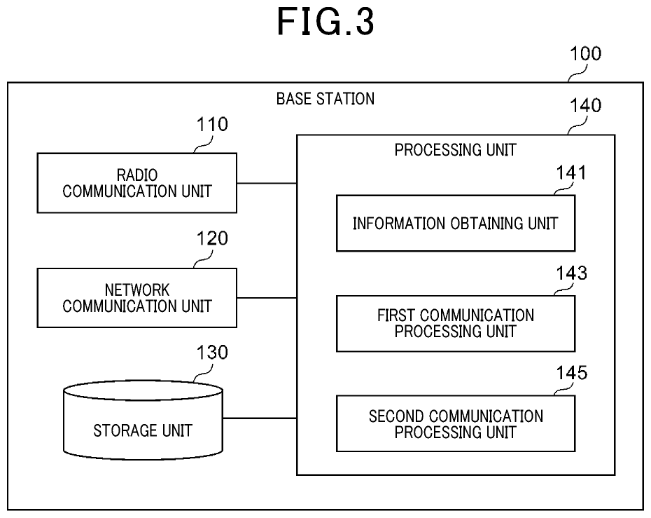

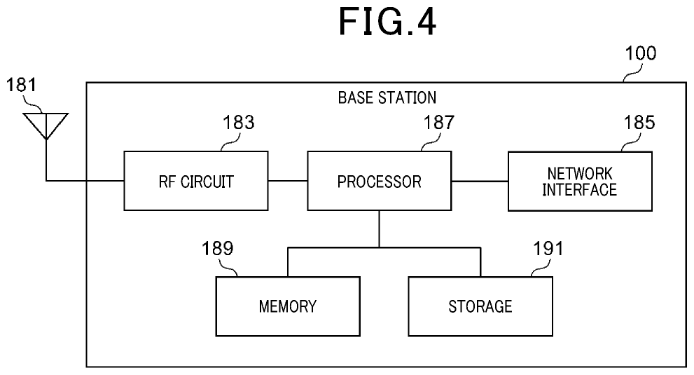

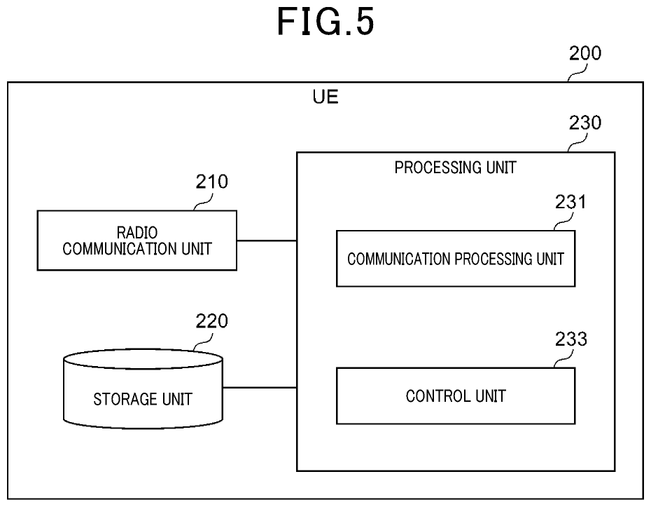

A configuration example of the base station 100 according to embodiments of the present disclosure will be described with reference to FIGS. 3 and 4.

(1) Functional Configuration

First, a functional configuration example of the base station 100 according to embodiments of the present disclosure will be described with reference to FIG. 3. Referring to FIG. 3, the base station 100 includes a radio communication unit 110, a network communication unit 120, a storage unit 130, and a processing unit 140.

The radio communication unit 110 wirelessly transmits and receives signals. For example, the radio communication unit 110 receives signals from and transmits signals to a UE.

The network communication unit 120 receives signals from and transmits signals to the network.

The storage unit 130 stores various information.

The processing unit 140 provides various functions of the base station 100. The processing unit 140 includes an information obtaining unit 141, a first communication processing unit 143, and a second communication processing unit 145. Note that the processing unit 140 may further include a component other than these components. That is, the processing unit 140 may also perform an operation other than operations of these components. Specific operations of the information obtaining unit 141, the first communication processing unit 143, and the second communication processing unit 145 will be described in detail later.

For example, the processing unit 140 (the first communication processing unit 143) communicates with a UE (for example, the UE 200) via the radio communication unit 110. For example, the processing unit 140 (the second communication processing unit 145) communicates with other nodes (for example, the network node 300 within the core network 30 or another base station) via the network communication unit 120.

(2) Hardware Configuration

Next, a hardware configuration example of the base station 100 according to embodiments of the present disclosure will be described with reference to FIG. 4. Referring to FIG. 4, the base station 100 includes an antenna 181, an RF circuit 183, a network interface 185, a processor 187, a memory 189, and a storage 191.

The antenna 181 converts signals into radio waves and emits the radio waves into the air. In addition, the antenna 181 receives radio waves in the air and converts the radio waves into signals. The antenna 181 may include a transmitting antenna and a receiving antenna, or may be a single antenna for transmission and reception. The antenna 181 may be a directional antenna and may include a plurality of antenna elements.

The RF circuit 183 performs analog processing on signals that are transmitted and received via the antenna 181. The RF circuit 183 may include a high-frequency filter, an amplifier, a modulator, a lowpass filter, and the like.

The network interface 185 is, for example, a network adaptor, and transmits signals to and receives signals from the network.

The processor 187 performs digital processing on signals that are transmitted and received via the antenna 181 and the RF circuit 183. The digital processing includes processing of the RAN protocol stack. The processor 187 also performs processing on signals that are transmitted and received via the network interface 185. The processor 187 may include a plurality of processors, or may be a single processor. The plurality of processors may include a baseband processor that performs the digital processing and one or more processors that perform other processing.

The memory 189 stores a program to be executed by the processor 187, parameters related to the program, and data related to the program. The memory 189 may include at least one of a read only memory (ROM), an erasable programmable read only memory (EPROM), an electrically erasable programmable read only memory (EEPROM), a random access memory (RAM), and a flash memory. All or part of the memory 189 may be included in the processor 187.

The storage 191 stores various information. The storage 191 may include at least one of a solid state drive (SSD) and a hard disc drive (HDD).

The radio communication unit 110 may be implemented by the antenna 181 and the RF circuit 183. The network communication unit 120 may be implemented by the network interface 185. The storage unit 130 may be implemented by the storage 191. The processing unit 140 may be implemented by the processor 187 and the memory 189.

Part or all of the processing unit 140 may be virtualized. In other words, part or all of the processing unit 140 may be implemented as a virtual machine. In this case, part or all of the processing unit 140 may operate as a virtual machine on a physical machine including a processor, a memory, and the like (that is, hardware) and a hypervisor.

Given the hardware configuration described above, the base station 100 may include a memory (that is, the memory 189) that stores a program and one or more processors (that is, the processor 187) capable of executing the program, and the one or more processors may be configured to execute the program to perform operations of the processing unit 140. The program may be a program for causing the processors to execute the operations of the processing unit 140.

### 3. Configuration of User Equipment

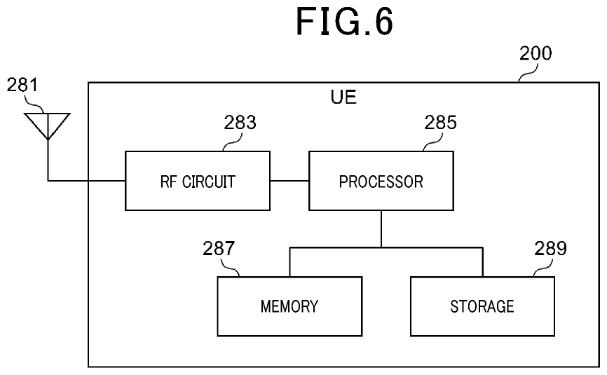

A configuration example of the UE 200 according to embodiments of the present disclosure will be described with reference to FIGS. 5 and 6.

(1) Functional Configuration

First, a functional configuration example of the UE 200 according to embodiments of the present disclosure will be described with reference to FIG. 5. Referring to FIG. 5, the UE 200 includes a radio communication unit 210, a storage unit 220, and a processing unit 230.

The radio communication unit 210 wirelessly transmits and receives signals. For example, the radio communication unit 210 receives signals from and transmits signals to a base station. For example, the radio communication unit 210 receives signals from and transmits signals to another UE.

The storage unit 220 stores various information.

The processing unit 230 provides various functions of the UE 200. The processing unit 230 includes a communication processing unit 231 and a control unit 233. Note that the processing unit 230 may further include a component other than these components. That is, the processing unit 230 may also perform an operation other than operations of these components. Specific operations of the communication processing unit 231 and the control unit 233 will be described in detail later.

For example, the processing unit 230 (the communication processing unit 231) communicates with a base station (for example, the base station 100 or the base station 40) or another UE via the radio communication unit 210.

(2) Hardware Configuration

Next, a hardware configuration example of the UE 200 according to embodiments of the present disclosure will be described with reference to FIG. 6. Referring to FIG. 6, the UE 200 includes an antenna 281, an RF circuit 283, a processor 285, a memory 287, and a storage 289.

The antenna 281 converts signals into radio waves and emits the radio waves into the air. In addition, the antenna 281 receives radio waves in the air and converts the radio waves into signals. The antenna 281 may include a transmitting antenna and a receiving antenna, or may be a single antenna for transmission and reception. The antenna 281 may be a directional antenna and may include a plurality of antenna elements.

The RF circuit 283 performs analog processing on signals that are transmitted and received via the antenna 281. The RF circuit 283 may include a high-frequency filter, an amplifier, a modulator, a lowpass filter, and the like.

The processor 285 performs digital processing on signals that are transmitted and received via the antenna 281 and the RF circuit 283. The digital processing includes processing of the RAN protocol stack. The processor 285 may include a plurality of processors, or may be a single processor. The plurality of processors may include a baseband processor that performs the digital processing and one or more processors that perform other processing.

The memory 287 stores a program to be executed by the processor 285, parameters related to the program, and data related to the program. The memory 287 may include at least one of a ROM, an EPROM, an EEPROM, a RAM, and a flash memory. All or part of the memory 287 may be included in the processor 285.

The storage 289 stores various information. The storage 289 may include at least one of an SSD and an HDD.

The radio communication unit 210 may be implemented by the antenna 281 and the RF circuit 283. The storage unit 220 may be implemented by the storage 289. The processing unit 230 may be implemented by the processor 285 and the memory 287.

The processing unit 230 may be implemented by a system on chip (SoC) including the processor 285 and the memory 287. The SoC may include the RF circuit 283, and the radio communication unit 210 may also be implemented by this SoC.

Given the hardware configuration described above, the UE 200 may include a memory (that is, the memory 287) that stores a program and one or more processors (that is, the processor 285) capable of executing the program, and the one or more processors may be configured to execute the program to perform operations of the processing unit 230. The program may be a program for causing the processors to execute the operations of the processing unit 230.

### 4. Configuration of Network Node

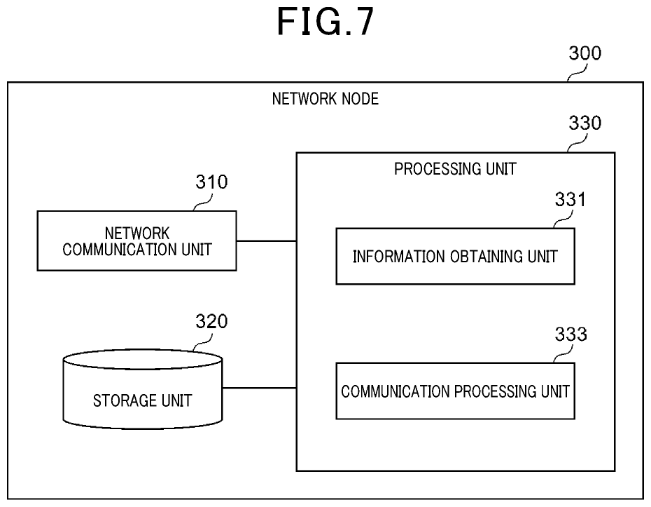

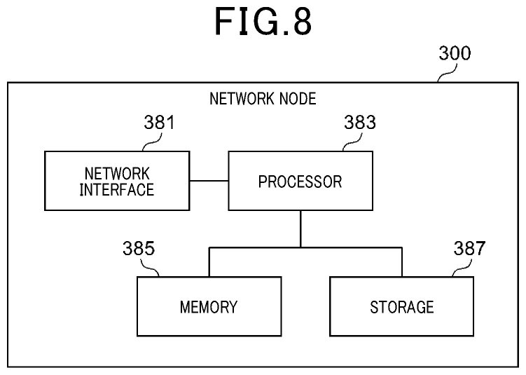

A configuration example of the network node 300 according to embodiments of the present disclosure will be described with reference to FIGS. 7 and 8.

(1) Functional Configuration

First, a functional configuration example of the network node 300 according to embodiments of the present disclosure will be described with reference to FIG. 7. Referring to FIG. 7, the network node 300 includes a network communication unit 310, a storage unit 320, and a processing unit 330.

The network communication unit 310 receives signals from and transmits signals to the network.

The storage unit 320 stores various information.

The processing unit 330 provides various functions of the network node 300. The processing unit 330 includes an information obtaining unit 331 and a communication processing unit 333. Note that the processing unit 330 may further include a component other than these components. That is, the processing unit 330 may also perform an operation other than operations of these components. Specific operations of the information obtaining unit 331 and the communication processing unit 333 will be described in detail later.

For example, the processing unit 330 (the communication processing unit 333) communicates with a base station (for example, the base station 100) via the network communication unit 310. For example, the processing unit 330 (the communication processing unit 333) communicates with a UE (for example, the UE 200) through a base station (for example, the base station 100) via the network communication unit 310.

(2) Hardware Configuration

Next, a hardware configuration example of the network node 300 according to embodiments of the present disclosure will be described with reference to FIG. 8. Referring to FIG. 8, the network node 300 includes a network interface 381, a processor 383, a memory 385, and a storage 387.

The network interface 381 is, for example, a network adaptor, and transmits signals to and receives signals from the network.

The processor 383 performs processing on signals that are transmitted and received via the network interface 381. The processor 383 may include a plurality of processors, or may be a single processor.

The memory 385 stores a program to be executed by the processor 383, parameters related to the program, and data related to the program. The memory 385 may include at least one of a ROM, an EPROM, an EEPROM, a RAM, and a flash memory. All or part of the memory 385 may be included in the processor 383.

The storage 387 stores various information. The storage 387 may include at least one of an SSD and an HDD.

The network communication unit 310 may be implemented by the network interface 381. The storage unit 320 may be implemented by the storage 387. The processing unit 330 may be implemented by the processor 383 and the memory 385.

Part or all of the processing unit 330 may be virtualized. In other words, part or all of the processing unit 330 may be implemented as a virtual machine. In this case, part or all of the processing unit 330 may operate as a virtual machine on a physical machine including a processor, a memory, and the like (that is, hardware) and a hypervisor.

Given the hardware configuration described above, the network node 300 may include a memory (that is, the memory 385) that stores a program and one or more processors (that is, the processor 383) capable of executing the program, and the one or more processors may be configured to execute the program to perform operations of the processing unit 330. The program may be a program for causing the processors to execute the operations of the processing unit 330.

### 5. Operation Examples

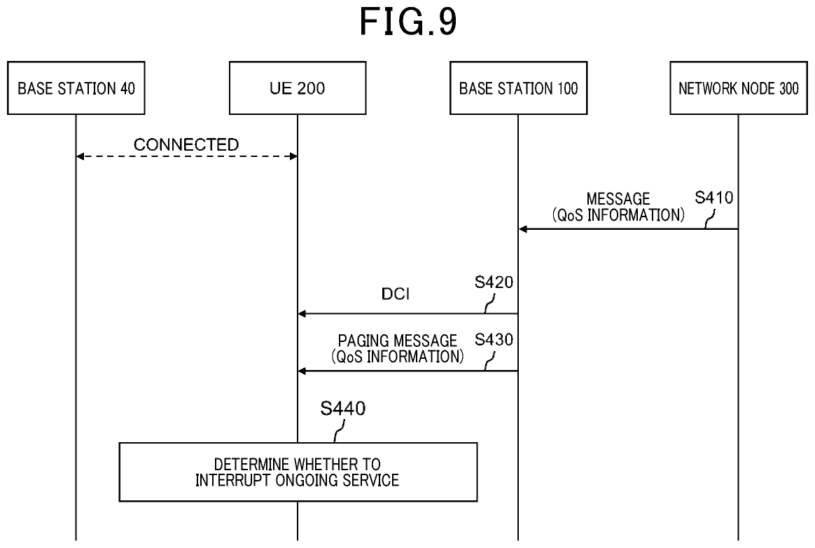

Operation examples of the base station 100, the UE 200, and the network node 300 according to embodiments of the present disclosure will be described with reference to FIG. 9.

The base station 100 (the information obtaining unit 141) obtains quality of service (QoS) information indicating QoS of a service for which a paging to the UE 200 is performed. The base station 100 (the first communication processing unit 143) transmits the QoS information with a paging message for the paging. The UE 200 (the communication processing unit 231) receives the QoS information.

This, for example, enables the UE 200 to more appropriately determine whether to interrupt an ongoing service in the second mobile network to respond to a paging in the first mobile network.

More specifically, for example, the UE 200 can know QoS of the service for which the paging is performed (that is, the service in the first mobile network) from the QoS information. Thus, the UE 200 can compare the service in the first mobile network with the ongoing service in the second mobile network in terms of QoS regardless of a type of service. Therefore, the UE 200 can more appropriately determine whether to interrupt the ongoing service.

(1) QoS Information

For example, the QoS information indicates a 5G QoS identifier (5QI) as the QoS. For example, the smaller the value of the 5QI, the higher the QoS.

Alternatively, the QoS information may indicate a QoS class identifier (QCI) as the QoS. For example, the smaller the value of the QCI, the higher the QoS.

(2) Obtainment of QoS Information

For example, the network node 300 (the information obtaining unit 331) obtains the QoS information. More specifically, for example, in a case where there is incoming data for the UE 200, the network node 300 (the information obtaining unit 331) identifies QoS of a service corresponding to the incoming data and obtains QoS information indicating the QoS.

Further, for example, the network node 300 (the communication processing unit 333) transmits, to the base station 100, a message for a paging to the UE 200, which includes the QoS information. The base station 100 (the second communication processing unit 145) receives the message from the network node 300. The base station 100 (the information obtaining unit 141) obtains the QoS information included in the message.

For example, the message for the paging includes an ID of the UE 200.

For example, the message for the paging is a paging message of an NG application protocol (NGAP) layer, and the ID of the UE 200 is 5G S-Temporary Mobile Subscriber Identity (5G-S-TMSI) of the UE 200. Alternatively, the message for the paging may be a paging message of an 51 application protocol (S1AP) layer, and the ID of the UE 200 may be the 10 least significant bits of International Mobile Subscriber Identity (IMSI).

This, for example, enables the base station 100 to obtain the QoS information in practice.

(3) Transmission Method for QoS Information

For example, the QoS information is included in the paging message for the paging. That is, the base station 100 (the first communication processing unit 143) transmits the paging message including the QoS information. The paging message is a paging message of an RRC layer.

For example, the paging message includes a plurality of paging records respectively corresponding to a plurality of UEs. The QoS information is included in a paging record corresponding to the UE 200 among the plurality of paging records.

This, for example, makes it possible to provide QoS information to the UE 200 at the time of a paging.

For example, each of the plurality of paging records includes both an ID of a UE and QoS information.

Alternatively, the paging message may include a first paging record list and a second paging record list that includes the plurality of paging records. The first paging record list may include a plurality of other paging records, each of which may include an ID of a UE. The first paging record list and the second paging record list may include the same number of paging records.

For example, an ID of a UE included in a paging record is 5G-S-TMSI or full inactive radio network temporary identifier (I-RNTI). Alternatively, an ID of a UE included in a paging record may be SAE temporary mobile subscriber identity (S-TMSI) or international mobile subscriber identity (IMSI).

(4) Determination Based on QoS Information

Determination

For example, the UE 200 (the control unit 233) determines, based on the QoS information, whether to interrupt an ongoing service in the second mobile network. In other words, the UE 200 (the control unit 233) determines, based on the QoS information, whether to interrupt the ongoing service and respond to the paging (that is, to start the service in the first mobile network) or to continue the ongoing service.

For example, the QoS indicated by the QoS information is higher than QoS of the ongoing service. That is, the value of a 5QI or a QCI indicated by the QoS information is smaller than the value of a 5QI or a QCI of the ongoing service. In this case, the UE 200 (the control unit 233) determines to interrupt the ongoing service.

For example, the QoS indicated by the QoS information is lower than QoS of the ongoing service. That is, the value of a 5QI or a QCI indicated by the QoS information is greater than the value of a 5QI or a QCI of the ongoing service. In this case, the UE 200 (the control unit 233) determines to continue the ongoing service.

This, for example, enables the UE 200 to more appropriately determine whether to interrupt an ongoing service in the second mobile network to respond to a paging in the first mobile network.

Operation after Determination

For example, in a case where the UE 200 (the control unit 233) determines to interrupt the ongoing service, the UE 200 (the communication processing unit 231) performs a procedure for interrupting the ongoing service in the second mobile network. Further, the UE 200 (the communication processing unit 231) responds to the paging message in the first mobile network.

For example, in a case where the UE 200 (the control unit 233) determines to continue the ongoing service, the UE 200 (the communication processing unit 231) continues the ongoing service in the second mobile network and does not respond to the paging message in the first mobile network.

(5) Flow of Processing

An example of processing according to embodiments of the present disclosure will be described with reference to FIG. 9.

As an assumption, the UE 200 is in the RRC idle state or RRC inactive state in the first mobile network including the base station 100 and the network node 300, and is in the RRC connected state in the second mobile network including the base station 40 and is connected to the base station 40.

The network node 300 transmits, to the base station 100, a message for a paging to the UE 200 (S410). The message includes QoS information indicating QoS of a service for which the paging is performed. The base station 100 receives the message from the network node 300. The base station 100 obtains the QoS information included in the message.

The base station 100 transmits, on a physical downlink control channel (PDCCH), downlink control information (DCI) including resource allocation information to transmit a paging message for the paging (S420). The UE 200 receives the DCI.

The base station 100 transmits the paging message (S430). The paging message includes an ID of the UE 200 and the QoS information. The UE 200 receives the paging message based on the resource allocation information included in the DCI. The UE 200 obtains the QoS information included in the paging message.

The UE 200 determines, based on the QoS information, whether to interrupt an ongoing service in the second mobile network (S440). Then, the UE 200 performs an operation depending on a result of this determination.

### 6. Modification Examples

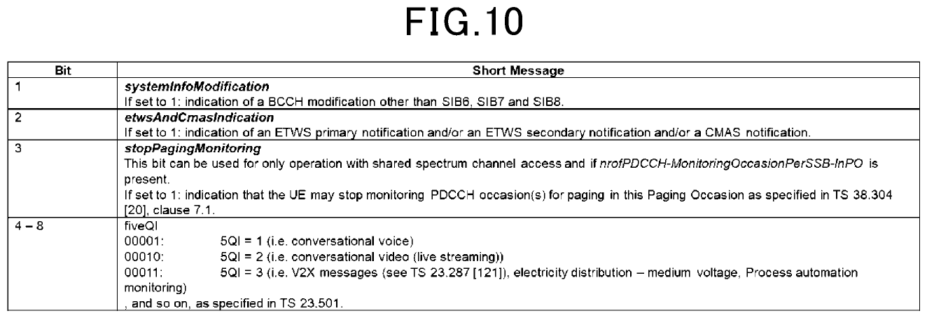

First and second modification examples according to embodiments of the present disclosure will be described with reference to FIGS. 10 to 14. Note that the two modification examples may be combined with each other.

### (1) First Modification Example

In the above-described example of embodiments of the present disclosure, the QoS information is included in the paging message for the paging. That is, the base station 100 (the first communication processing unit 133) transmits the QoS in the paging message. However, the transmission method for the QoS information according to embodiments of the present disclosure is not limited to this example.

As a first modification example of embodiments of the present disclosure, the base station 100 (the first communication processing unit 133) may transmit, on a PDCCH, DCI including resource allocation information to transmit the paging message and including the QoS information.

QoS Information

The DCI may include a short message, and the short message may include the QoS information.

Alternatively, the DCI may include direct indication information, and the direct indication information may include the QoS information.

This, for example, makes it possible to transmit the QoS information using an unused bit of DCI without adding new information to a paging message.

### A Plurality of Bits (First Example)

The QoS information may include a plurality of bits, and each possible value of the plurality of bits may correspond to possible QoS.

Referring to the example of FIG. 10, a short message included in DCI is illustrated. The QoS information may be the fourth to eighth bits (that is, five bits) in the short message. For example, possible values of 00001, 00010, and 00011 may correspond to 5QI=1, 5QI=2, and 5QI=3, respectively.

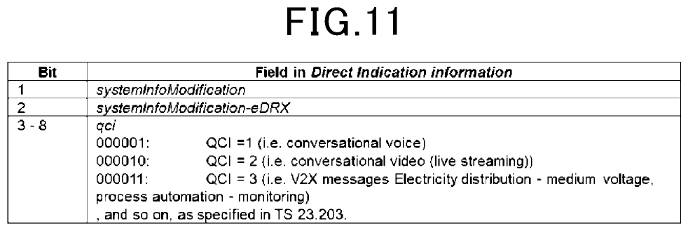

Referring to the example of FIG. 11, direct indication information included in DCI is illustrated. The QoS information may be the third to eighth bits (that is, six bits) in the direct indication information. For example, possible values of 000001, 000010, and 000011 may correspond to QCI=1, QCI=2, and QCI=3, respectively.

This, for example, increases the number of possible QoS values that can be indicated by the QoS information.

### A Plurality of Bits (Second Example)

Alternatively, the QoS information may include a plurality of bits, and each bit included in the plurality of bits may correspond to possible QoS.

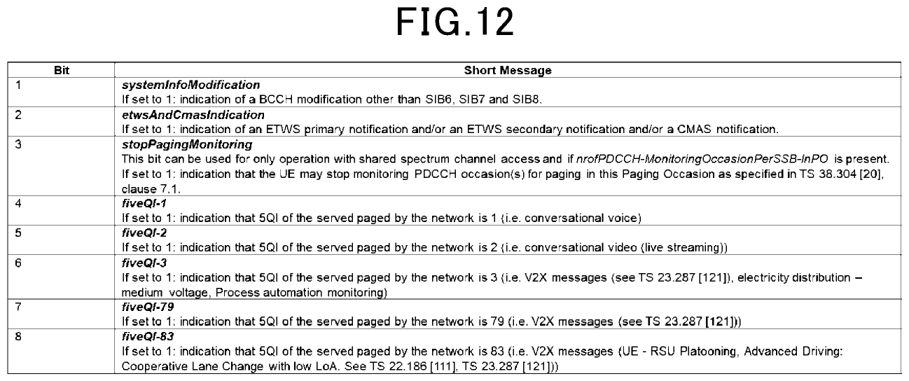

Referring to the example of FIG. 12, a short message included in DCI is illustrated. The QoS information may be the fourth to eighth bits (that is, five bits) in the short message. For example, if the fourth bit is set to 1, the fourth bit may indicate 5QI=1. If the fifth bit is set to 1, the fifth bit may indicate 5QI=2. The sixth bit, the seventh bit, and the eighth bit may similarly indicate 5QI=3, 5QI=79, and 5QI=83, respectively.

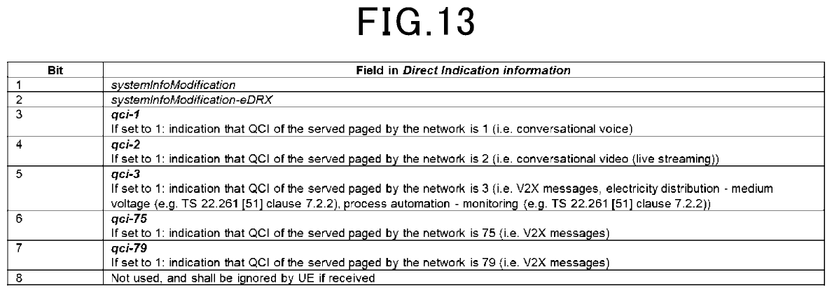

Referring to the example of FIG. 13, direct indication information included in DCI is illustrated. The QoS information may be the third to seventh bits (that is, five bits) in the direct indication information. For example, if the third bit is set to 1, the third bit may indicate QCI=1. If the fourth bit is set to 1, the fourth bit may indicate QCI=2. The fifth bit, the sixth bit, and the seventh bit may similarly indicate QCI=3, QCI=75, and QCI=79, respectively.

Flow of Processing

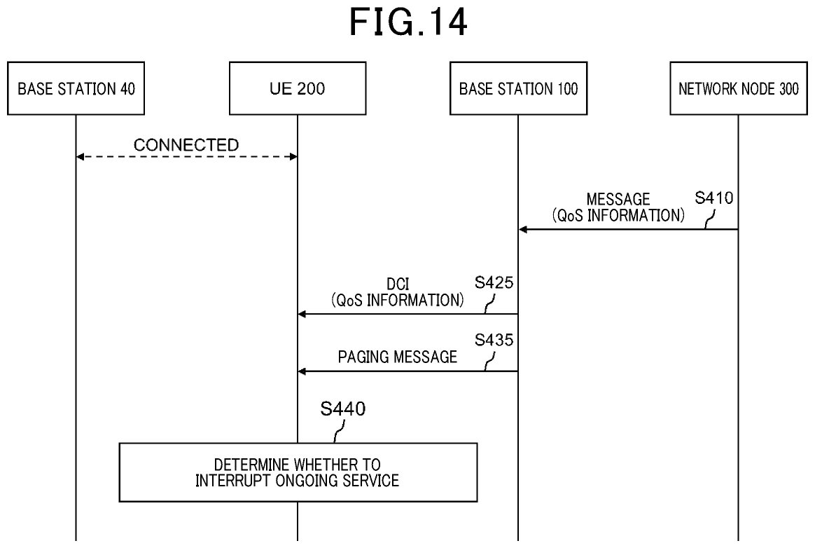

An example of processing according to the first modification example of embodiments of the present disclosure will be described with reference to FIG. 14.

Descriptions of assumption of the processing, step S410 and step S440 are the same as the description with reference to FIG. 9. Thus, only step S425 and step S435 will be described here.

The base station 100 transmits, on a PDCCH, DCI including resource allocation information to transmit a paging message for the paging (S425). The DCI includes the QoS information. The UE 200 receives the DCI. The UE 200 obtains the QoS information included in the DCI.

The base station 100 transmits the paging message (S435). The UE 200 receives the paging message based on the resource allocation information included in the DCI.

### (2) Second Modification Example

In the above-described examples of embodiments of the present disclosure, the system 1 is a system compliant with TSs of 5G or NR, or a system compliant with TSs of LTE, LTE-A, or 4G. However, the system 1 according to embodiments of the present disclosure is not limited to these examples.

As a second modification example of embodiments of the present disclosure, the system 1 may be a system compliant with other 3GPP TSs. As an example, the system 1 may be a system compliant with next-generation (for example, 6G) TSs.

Alternatively, the system 1 may be a system compliant with TSs of another standardization organization for mobile communications.

### 7. Further Embodiment

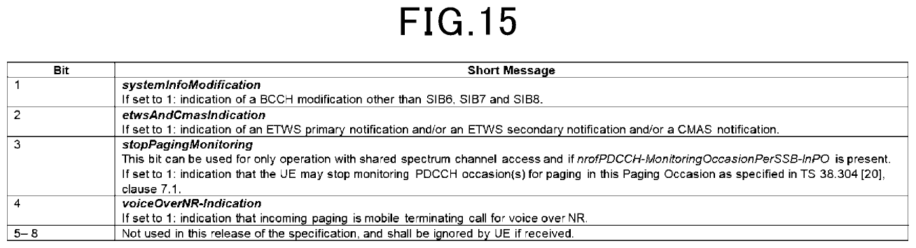

A further embodiment will be described with reference to FIGS. 15 to 18.

In the above-described first modification example of embodiments of the present disclosure, service related information regarding the service for which the paging to the UE 200 is performed may be used instead of the QoS information.

That is, the base station 100 (the information obtaining unit 141) may obtain the service related information. The base station 100 (the first communication processing unit 143) may transmit, on a PDCCH, DCI including the resource allocation information and the service related information.

DCI

The DCI may include a short message, and the short message may include the service related information. Alternatively, the DCI may include direct indication information, and the direct indication information may include the service related information.

Service Related Information

The service related information may indicate that the service is a specific service. As an example, the service related information may indicate whether the service is a voice service. The voice service may be VoNR or VoLTE. In this case, the service related information may be 1-bit information indicating whether the service is a voice service.

Referring to the example of FIG. 15, a short message included in DCI is illustrated. The service related information may be the fourth bit.

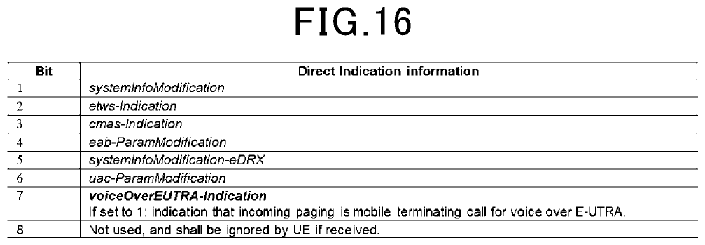

Referring to the example of FIG. 16, direct indication information included in DCI transmitted on a machine type communication physical downlink control channel (MPDCCH) is illustrated. The service related information may be the seventh bit.

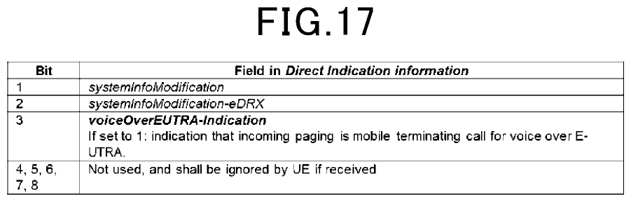

Referring to the example of FIG. 17, direct indication information included in DCI transmitted on a narrow band physical downlink control channel (NPDCCH) is illustrated. The service related information may be the third bit.

Flow of Processing

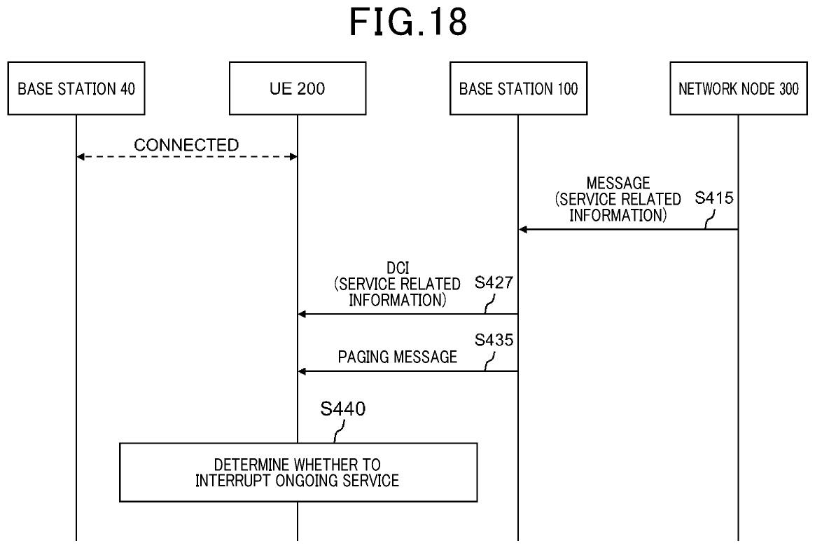

Referring to the example of FIG. 18, not the QoS information but the service related information is transmitted in step S415 and step S427.

While embodiments of the present disclosure have been described above, the present disclosure is not limited to the embodiments. It will be understood by those skilled in the art that the embodiments are merely examples and various changes can be made without departing from the scope and the spirit of the present disclosure.

For example, steps in a process described in the present specification are not necessarily executed chronologically in the order described in the flowchart or sequence diagram. For example, steps in a process may be executed in an order different from the order described as the flowchart or sequence diagram, or may be executed in parallel. In addition, one or more steps in a process may be removed, or one or more further steps may be added to the process.

For example, there may be provided a method including the operations of one or more components of an apparatus described in the present specification, and there may be provided a program for causing a computer to execute the operations of the components. Moreover, there may be provided a non-transitory tangible computer-readable storage medium having stored therein the program. Naturally, such a method, program, and non-transitory tangible computer-readable storage medium are also included in the present disclosure.

For example, in the present disclosure, a user equipment (UE) may be referred to by another name such as mobile station, mobile terminal, mobile device, mobile unit, subscriber station, subscriber terminal, subscriber device, subscriber unit, wireless station, wireless terminal, wireless device, wireless unit, remote station, remote terminal, remote device, or remote unit.

For example, in the present disclosure, “transmit” may mean performing processing of at least one layer in a protocol stack used for transmission, or physically transmitting signals wirelessly or by wire. Alternatively, “transmit” may mean a combination of performing processing of the at least one layer and physically transmitting signals wirelessly or by wire. Similarly, “receive” may mean performing processing of at least one layer in a protocol stack used for reception, or physically receiving signals wirelessly or by wire. Alternatively, “receive” may mean a combination of performing processing of the at least one layer and physically receiving signals wirelessly or by wire.

For example, in the present disclosure, “obtain/acquire” may mean obtaining/acquiring information from stored information, obtaining/acquiring information from information received from another node, or obtaining/acquiring information by generating the information.

For example, in the present disclosure, “include” and “comprise” do not mean that only listed items are included, but mean that only listed items may be included or a further item may be included in addition to the listed items.

For example, in the present disclosure, “or” does not mean exclusive OR but means inclusive OR.

Note that the technical features included in the above-described embodiments may be represented as the following features. Naturally, the present disclosure is not limited to the following features.

### (Feature 1)

A base station (100) comprising:

an information obtaining unit (141) configured to obtain quality of service, QoS, information indicating QoS of a service for which a paging to a user equipment (200) is performed; and

a communication processing unit (143) configured to transmit the QoS information with a paging message for the paging.

### (Feature 2)

The base station according to Feature 1, wherein the QoS information indicates a 5G QoS identifier, 5QI, or a QoS class identifier, QCI, as the QoS.

### (Feature 3)

The base station according to Feature 1 or 2, wherein the QoS information is included in the paging message.

### (Feature 4)

The base station according to Feature 3, wherein

the paging message includes a plurality of paging records respectively corresponding to a plurality of user equipments, and

the QoS information is included in a paging record corresponding to the user equipment among the plurality of paging records.

### (Feature 5)

The base station according to Feature 1 or 2, wherein the communication processing unit is configured to transmit, on a physical downlink control channel, PDCCH, downlink control information including resource allocation information to transmit the paging message and including the QoS information.

### (Feature 6)

The base station according to Feature 5, wherein the QoS information is included in a short message or direct indication information in the downlink control information.

### (Feature 7)

The base station according to Feature 5 or 6, wherein

the QoS information includes a plurality of bits, and

each possible value of the plurality of bits corresponds to possible QoS.

### (Feature 8)

The base station according to Feature 5 or 6, wherein

the QoS information includes a plurality of bits, and

each bit included in the plurality of bits corresponds to possible QoS.

### (Feature 9)

The base station according to any one of Features 1 to 8, further comprising:

a further communication processing unit (145) configured to receive, from a network node (300) within a core network (30), a message for the paging, the message including the QoS information,

wherein the information obtaining unit is configured to obtain the QoS information included in the message.

### (Feature 10)

The base station according to any one of Features 1 to 9, wherein the user equipment is capable of being equipped with two or more subscriber identity module, SIM, cards, and is capable of communicating in two or more mobile networks respectively corresponding to the two or more SIM cards.

### (Feature 11)

A user equipment (200) comprising:

a communication processing unit (231) configured to receive quality of service, QoS, information indicating QoS of a service for which a paging to the user equipment is performed, the QoS information being transmitted with a paging message for the paging by a base station (100); and

a control unit (233) configured to determine, based on the QoS information, whether to interrupt an ongoing service in a further mobile network.

### (Feature 12)

The user equipment according to Feature 11, wherein the further mobile network is different from a mobile network including the base station.

### (Feature 13)

A network node (300) within a core network (30) comprising:

an information obtaining unit (331) configured to obtain quality of service, QoS, information indicating QoS of a service for which a paging to a user equipment (200) is performed; and

a communication processing unit (333) configured to transmit, to a base station (100), a message for the paging, the message including the QoS information.

### (Feature 14)

A method performed by a base station (100), comprising:

obtaining quality of service, QoS, information indicating QoS of a service for which a paging to a user equipment (200) is performed; and

transmitting the QoS information with a paging message for the paging.

### (Feature 15)

A method performed by a user equipment (200), comprising:

receiving quality of service, QoS, information indicating QoS of a service for which a paging to the user equipment is performed, the QoS information being transmitted with a paging message for the paging by a base station (100); and

determining, based on the QoS information, whether to interrupt an ongoing service in a further mobile network.

### (Feature 16)

A method performed by a network node (300) within a core network (30), comprising:
obtaining quality of service, QoS, information indicating QoS of a service for which a paging to a user equipment (200) is performed; and
transmitting, to a base station (100), a message for the paging, the message including the QoS information.

### (Feature 17)

A program that causes a computer to execute operations of:

obtaining quality of service, QoS, information indicating QoS of a service for which a paging to a user equipment (200) is performed; and

transmitting the QoS information with a paging message for the paging.

### (Feature 18)

A program that causes a computer to execute operations of:

receiving quality of service, QoS, information indicating QoS of a service for which a paging to a user equipment (200) is performed, the QoS information being transmitted with a paging message for the paging by a base station (100); and

determining, based on the QoS information, whether to interrupt an ongoing service in a further mobile network.

### (Feature 19)

A program that causes a computer to execute operations of:

obtaining quality of service, QoS, information indicating QoS of a service for which a paging to a user equipment (200) is performed; and

transmitting, to a base station (100), a message for the paging, the message including the QoS information.

### (Feature 20)

A non-transitory tangible computer-readable storage medium having stored therein a program that causes a computer to execute operations of:

obtaining quality of service, QoS, information indicating QoS of a service for which a paging to a user equipment (200) is performed; and

transmitting the QoS information with a paging message for the paging.

### (Feature 21)

A non-transitory tangible computer-readable storage medium having stored therein a program that causes a computer to execute operations of:

receiving quality of service, QoS, information indicating QoS of a service for which a paging to a user equipment (200) is performed, the QoS information being transmitted with a paging message for the paging by a base station (100); and

determining, based on the QoS information, whether to interrupt an ongoing service in a further mobile network.

### (Feature 22)

A non-transitory tangible computer-readable storage medium having stored therein a program that causes a computer to execute operations of:

obtaining quality of service, QoS, information indicating QoS of a service for which a paging to a user equipment (200) is performed; and

transmitting, to a base station (100), a message for the paging, the message including the QoS information.

What is claimed is:

1. A base station (100) comprising:
a memory storing a program; and
one or more processors configured to execute the program to:
obtain quality of service, QoS, information indicating QoS of a service for which a paging to a user equipment (200) is performed; and
transmit the QoS information with a paging message for the paging.

2. The base station according to claim 1, wherein the QoS information indicates a 5G QoS identifier, 5QI, or a QoS class identifier, QCI, as the QoS.

3. The base station according to claim 1, wherein the QoS information is included in the paging message.

4. The base station according to claim 3, wherein
the paging message includes a plurality of paging records respectively corresponding to a plurality of user equipments, and
the QoS information is included in a paging record corresponding to the user equipment among the plurality of paging records.

5. The base station according to claim 1, wherein the one or more processors are configured to execute the program to transmit, on a physical downlink control channel, PDCCH, downlink control information including resource allocation information to transmit the paging message and including the QoS information.

6. The base station according to claim 5, wherein the QoS information is included in a short message or direct indication information in the downlink control information.

7. The base station according to claim 5, wherein
the QoS information includes a plurality of bits, and
each possible value of the plurality of bits corresponds to possible QoS.

8. The base station according to claim 5, wherein
the QoS information includes a plurality of bits, and
each bit included in the plurality of bits corresponds to possible QoS.

9. The base station according to claim 1, wherein the one or more processors are configured to execute the program to:
receive, from a network node (300) within a core network (30), a message for the paging, the message including the QoS information, and
obtain the QoS information included in the message.

10. The base station according to any one of claim 1, wherein the user equipment is capable of being equipped with two or more subscriber identity module, SIM, cards, and is capable of communicating in two or more mobile networks respectively corresponding to the two or more SIM cards.

11. A user equipment (200) comprising:
a memory storing a program; and
one or more processors configured to execute the program to:
receive quality of service, QoS, information indicating QoS of a service for which a paging to the user equipment is performed, the QoS information being transmitted with a paging message for the paging by a base station (100); and
determine, based on the QoS information, whether to interrupt an ongoing service in a further mobile network.

12. The user equipment according to claim 11, wherein the further mobile network is different from a mobile network including the base station.

13. A network node (300) within a core network (30) comprising:
a memory storing a program; and
one or more processors configured to execute the program to:
obtain quality of service, QoS, information indicating QoS of a service for which a paging to a user equipment (200) is performed; and
transmit, to a base station (100), a message for the paging, the message including the QoS information.
